(19) United States
(12) Patent Application Publication
(10) Pub. No.: US 2007/0010761 A1
(43) Pub. Date: Jan. 11, 2007

(54) Method and apparatus for verifying data measured by several means in real-time

(76) Inventor: Seung-Kee Mo, Seoul (KR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/552,491

(22) PCT Filed: Apr. 9, 2003
(86) PCT No.: PCT/KR03/00705

§ 371 Date: Oct. 6, 2005

(30) Foreign Application Priority Data
Apr. 7, 2003 (KR) 10-2003-0021632

(51) Int. Cl. A61D 5/00

(52) U.S. Cl. 600/581

(57) ABSTRACT

The present invention relates to a method and an apparatus for verifying data measured by several means in real-time. In an urodynamics system according to the present invention, in the course of filling the bladder with a liquid through a liquid injecting lumen of a bladder inserting catheter inserted into the bladder through an urethra, a first pressure sensor connected to the liquid injecting lumen measures a dynamic pressure value in the liquid injecting lumen and transmits the dynamic pressure value to a control unit, a second pressure sensor connected to a liquid ejecting lumen measures a static pressure value in the bladder and transmits the static pressure value to the control unit, and then the control unit compares the dynamic pressure value with the static pressure value to verify validity of the measured data and displays a result of the validity verification in a display section. Therefore, it is possible to detect various data through once insertion of a catheter, and to verify validity of the data detected through the data detection.

### BACKGROUND OF THE INVENTION

1. Field of the Invention

The present invention relates to a method and an apparatus for verifying data measured by several means in real-time, and specifically to a method and an apparatus for verifying bidirectional data in real time, capable of providing a reliable result of inspection without any error by mutually verifying data obtained through various measuring methods for diagnosing of urination disorder.

2. Description of the Related Art

A lower urinary tract comprising a bladder and a urethra is an organ having two functions of storage of urine and elimination of urine, and an autonomic nervous system is deeply associated with the functions.

A central nerve system (CNS) generally managing the functions of the lower urinary tract is distributed in a brain, a backbone and so on. When this organ is in disorder, symptoms (that is, clinical symptoms or subjective symptoms) such as urinary incontinence, urinary frequency, constipation, feces incontinence and so on may appear.

The urination disorder of a human body can be divided into elimination disorder and storage disorder, and the urination disorder can result from disorders of a bladder and an urethra or any one thereof.

The diagnosis of urination disorder (elimination disorder or storage disorder) is carried out in the course of a process (storage process) of filling any liquid (for example, physiological salt solution) in a bladder and an urethra and a process (elimination process) of eliminating the physiological salt solution from the filled bladder.

A conventional urodynamics system (UDS) generally employs two lumen catheter as a bladder inserting catheter which is inserted into the bladder through the urethra. One lumen of the two lumen catheter is connected to a pump provided to pump the physiological salt solution through a hose, and the other lumen is connected to a pressure sensor through a hose.

In general, 0.9% isotonic sodium chloride solution of 1000 ml is widely used as the physiological salt solution. It is because the 0.9% isotonic sodium chloride solution is harmless to a human body, and the maximum volume of the bladder does not exceed 1000 ml.

A method of inspecting the urination disorder using the conventional urodynamics system is as follows.

First, a process of inspecting the storage disorder will be described.

A patient is made to empty his bladder in a natural state, and an operator (for example, a doctor) of the urodynamics system inserts a catheter into the bladder through the urethra to allow the residual urine in the bladder to be elminated.

Then, if the overall residual urine is eliminated through the catheter, one lumen (that is, one hole) of two lumens (that is, two holes) of the catheter protruded externally is connected to the pump and the physiological salt solution in this order through a hose. In addition, the other lumen (that is, the other hole) of the catheter is connected to a pressure sensor and a meter in this order.

If the connection is completed, the operator (for example, a doctor) of the urodynamics system activates the pump to fill the bladder with the physiological salt solution slowly. This process results in the same effect as filing the urine in the bladder in the natural state, and the bladder gives a physical reaction correspondingly to the process.

Two parameter values are measured by the pressure sensor connected to the other side of the catheter, wherein the two parameter values include an amount (volume) of physiological salt solution in which the bladder gives a physical reaction in the course of filing the physiological salt solution and a pressure at that time.

Then, a process of inspecting the elimination disorder will be described.

First, the hose of the catheter connected to the pump is removed to allow the patient to be in a natural state, and then a patient applies a force to his abdomen as urinating naturally to eliminate the physiological salt solution filling in the bladder through the urethra. At that time, the elimination pressure and the elimination volume can be calculated by use of the pressure sensor and the meters connected to the other side of the catheter, in the same principle as in the process of inspecting the storage disorder.

The urination disorder of a patient can be inspected through the process of inspecting the storage disorder and the process of inspecting the elimination disorder.

However, since the catheter is inserted into the bladder through the urethra several times to obtain necessary data, the conventional urodynamics system (UDS) has problems that the inspection time is long and a patient is made to feel considerably painful.

Further, in the conventional urodynamics system (UDS), the measured data such as a pressure obtained through only any one process of a process of filling the bladder with liquid (storage process) and a process of eliminating the liquid from the bladder (elimination process) is used. Therefore, although various error factors such as generation of errors, non-adjustment of zero point or the like exist in the course of measurement, it cannot be verified whether the measured data is valid or not.

For example, in the conventional urodynamics system, since the pumping is carried out in one side of the catheter and the measurement is carried out in the other side of the catheter, a user cannot detect a failure when the failure is generated in the pressure sensor itself or a place other than the pressure sensor.

Furthermore, the conventional urodynamics system has another problem that the measured data obtained in the course of the storage process or the elimination process can be uncertain and inconsistent data due to the non-adjustment of zero point, disagreement of reference value or the like.

### SUMMARY OF THE INVENTION

Therefore, it is an object of the present invention to provide a method and an apparatus for verifying data measured by several means in real-time, capable of carrying out the overall inspection processes through only one insertion of a catheter to minimize a pain of a patient and an inspection time.

Further, it is another object of the present invention to provide a method and an apparatus for verifying data measured by several means in real-time, capable of providing a function of adjusting a zero point for verification of errors or reduction of errors by employing a bidirectional data detecting method and allowing data measured in real time to be compared mutually.

Furthermore, it is still another object of the present invention to provide a method and an apparatus for verifying data measured by several means in real-time, in which certainty and consistency of the measured data can be maintained due to the verification function by the mutual comparison of the measured data and the zero-point adjustment function.

In order to accomplish the above objects, according to one aspect of the present invention, an urodynamics system having a function of verifying bidirectional data in real time is provided, in which urination disorder of a bladder is diagnosed in the course of filling the bladder with a liquid and ejecting the liquid from the bladder, the system comprising: a bladder inserting catheter having three or more lumens and being inserted into the bladder through an urethra to fill the bladder with the liquid and eject the liquid from the bladder, wherein the three or more lumens including at least a liquid injecting lumen, a liquid ejecting lumen and an urethra pressure measuring lumen; a liquid distributing section for distributing the liquid into at least any one of the liquid injecting lumen and the urethra pressure measuring lumen; a pumping section having a tube, a pump and a motor, for supplying the liquid to the liquid distributing section; a data detecting section provided between the bladder inserting catheter and the liquid distributing section, for detecting pressure data measured using the respective lumens of the bladder inserting catheter, wherein the data detecting section having pressure sensors connected to the corresponding lumens; and a control unit for verifying validity of the pressure data detected by the data detecting section, and controlling the pumping section and the data detecting section in accordance with a result of the validity verification or an instruction input by a user.

The liquid may be a physiological salt solution for scrub or disinfection.

Here, in the course of filing the bladder with the liquid through the liquid injecting lumen, the data detecting section may measure a dynamic pressure value in the liquid injecting lumen using a first pressure sensor connected to the liquid injecting lumen, measure a static pressure value in the bladder using a second pressure sensor connected to the liquid ejecting lumen, and supply the dynamic pressure value and the static pressure value to the control unit. In the course of ejecting the liquid filling in the bladder through the liquid ejecting lumen, the data detecting section may measure the dynamic pressure value in the liquid ejecting lumen using the second pressure sensor connected to the liquid ejecting lumen, measure the static pressure value in the bladder using the first pressure sensor connected to the liquid injecting lumen, and supply the dynamic pressure value and the static pressure value to the control unit. Then, the control unit may compare the dynamic pressure value and the static pressure value to verify the validity of the measured data.

Furthermore, the data detecting section of the urodynamics system according to the present invention may comprise a liquid injecting section for injecting a liquid equal to the liquid for adjustment of zero point when the zero points of the first pressure sensor and the second pressure sensor are not equal to each other.

Furthermore, the urodynamics system according to the present invention may further comprise a rectum inserting catheter of which an end portion is coupled to a sealed balloon and which is inserted into a rectum through the anus for measuring a rectum pressure. In this case, the liquid distributing section further distributes the liquid into the rectum inserting catheter, and the data detecting section is provided between the rectum inserting catheter and the liquid distributing section and further detects a pressure data measured by the rectum inserting catheter.

Furthermore, the urodynamics system according to the present invention may further comprise an abdominal electromyogram electrode to be attached to a human body, as a biological signal measuring electrode for detecting influence which a force applied to an abdomen in urination gives to an urination system, and the control unit compares a pressure value corresponding to a voltage value measured using the abdominal electromyogram electrode with the rectum pressure measured using the rectum inserting catheter, and verifies validity of the measured data.

Furthermore, the urodynamics system according to the present invention may further comprise a flow rate adjusting section provided at a front stage of the pumping section, for supplying a small amount of the liquid to the pumping section, in order to measure an urethra pressure using the urethra pressure measuring lumen.

Furthermore, the urodynamics system according to the present invention may further comprises a mono-carrier connected to the bladder inserting catheter, for inserting or pulling out the bladder inserting catheter through the urethra at a constant speed.

Furthermore, the urodynamics system according to the present invention may further comprise a flow rate measuring section for measuring an amount of residual urine or physiological salt solution ejected from the bladder when the residual urine in the bladder or the physiological salt solution filling in the bladder is ejected through the liquid ejecting lumen.

Furthermore, the urodynamics system according to the present invention may further comprise a residual urine detecting section in which a current flowing through a first electrode, the bladder and a second electrode flows. In this case, the control unit calculates the amount of residual urine in the bladder using a magnitude of the current flowing through the first electrode, the bladder and the second electrode and an impedance value calculated from a potential difference between the first electrode and the second electrode, and compares the amount of residual urine with a flow rate measured by the flow rate measuring section to verify the validity of the measured data.

According to another aspect of the present invention, a method of verifying in real time bidirectional data in an urodynamice system for diagnosing urination disorder of a bladder in the course of filling the bladder with liquid and ejecting the liquid from the bladder is provided, the urodynamics system comprising a bladder inserting catheter, a data detecting section and a control unit, the data detecting section having one or more pressure sensors, the method comprising: a step of filling the bladder with the liquid through a liquid injecting lumen of the bladder inserting catheter inserted into the bladder through an urethra, the bladder inserting catheter having at least the liquid injecting lumen, a liquid ejecting lumen and an urethra pressure measuring lumen; a step in which a first pressure sensor connected to the liquid injecting lumen measures a dynamic pressure value in the liquid injecting lumen and transmits the dynamic pressure value to the control unit, in the course of filling the bladder; a step in which a second pressure sensor connected to the liquid ejecting lumen measures a static pressure value in the bladder and transmits the static pressure value to the control unit, in the course of filling the bladder; a step in which the control unit compares the dynamic pressure value with the static pressure value to verify validity of the measured pressure value; and a step of displaying a result of the validity verification in a display section.

The method of verifying bidirectional data in real time according to the present invention may further comprise: a step of ejecting the liquid filling in the bladder through the liquid ejecting lumen; a step in which the first pressure sensor connected to the liquid injecting lumen measures the static pressure value in the bladder and transmits the static pressure value to the control unit, in the course of ejecting the liquid from the bladder; a step in which the second pressure sensor connected to the liquid ejecting lumen measures the dynamic pressure value in the liquid ejecting lumen and transmits the dynamic pressure value to the control unit, in the course of ejecting the liquid from the bladder; a step in which the control unit compares the dynamic pressure value with the static pressure value to verify validity of the measured pressure value; and a step of displaying a result of the validity verification in a display section.

When the urodynamics system further comprises a rectum inserting catheter of which an end portion is coupled to a sealed balloon and which is inserted into a rectum through an anus for measuring a rectum pressure, and an abdominal electromyogram electrode to be attached to a human body, as a biological signal measuring electrode for detecting influence which a force applied to an abdomen in urination gives to an urination system, the method of verifying bidirectional data in real time according to the present invention may further comprise: a step in which a third pressure sensor connected to the rectum inserting catheter inserted through the anus measures the rectum pressure and transmits the rectum pressure to the control unit; a step in which the control unit compares a pressure value corresponding to a voltage value measured using the abdominal electromyogram electrode with the rectum pressure to verify validity of the measured data; and a step of displaying a result of the validity verification in a display section.

In a case that the urodynamics system further comprises a flow rate measuring section for measuring an amount of residual urine or physiological salt solution ejected from the bladder when the residual urine in the bladder or the physiological salt solution filling in the bladder is ejected through the liquid ejecting lumen, and a residual urine detecting section in which a current flowing through a first electrode, the bladder and a second electrode flows, the method of verifying bidirectional data in real time according to the present invention may further comprise: a step in which the control unit calculates the amount of residual urine in the bladder using a magnitude of the current flowing through the first electrode, the bladder and the second electrode and an impedance value calculated from a potential difference between the first electrode and the second electrode; a step in which the control unit compares the amount of residual urine with a flow rate measured by the flow rate measuring section to verify validity of the measured data; and a step of displaying a result of the validity verification in a display section.

According to another aspect of the present invention, a defecation disorder diagnosing apparatus having a function of verifying bidirectional data in real time is provided, in which defecation disorder is diagnosed in the course of filing a rectum with liquid and ejecting the liquid from the rectum, the apparatus comprising: a rectum inserting catheter having three or more lumens and being inserted into the rectum through an anus to fill the rectum with the liquid and eject the liquid from the rectum, wherein the three or more lumens including at least a liquid injecting lumen, a liquid ejecting lumen and an urethra pressure measuring lumen; a liquid distributing section for distributing the liquid into at least any one of the liquid injecting lumen and the urethra pressure measuring lumen; a pumping section having a tube, a pump and a motor, for supplying the liquid to the liquid distributing section; a data detecting section provided between the rectum inserting catheter and the liquid distributing section, for detecting pressure data measured using the respective lumens of the rectum inserting catheter, wherein the data detecting section having pressure sensors connected to the corresponding lumens; and a control unit for verifying validity of the pressure data detected by the data detecting section, and controlling the pumping section and the data detecting section in accordance with a result of the validity verification or an instruction input by a user.

In the course of filling the rectum with the liquid through the liquid injecting lumen, the data detecting section may measure a dynamic pressure value in the liquid injecting lumen using a first pressure sensor connected to the liquid injecting lumen, measure a static pressure value in the rectum using a second pressure sensor connected to the liquid ejecting lumen, and supply the dynamic pressure value and the static pressure value to the control unit. In the course of ejecting the liquid filling in the rectum through the liquid ejecting lumen, the data detecting section may measure the dynamic pressure value in the liquid ejecting lumen using the second pressure sensor connected to the liquid ejecting lumen, measure the static pressure value in the rectum using the first pressure sensor connected to the liquid injecting lumen, and supply the dynamic pressure value and the static pressure value to the control unit. Then, the control unit may compare the dynamic pressure value with the static pressure value to verify validity of the measured data.

Furthermore, the data detecting section may comprise a liquid injecting section for injecting a liquid equal to the liquid for adjustment of zero point when the zero points of the first pressure sensor and the second pressure sensor are not equal to each other.

Furthermore, the defecation disorder diagnosing apparatus having a function of verifying bidirectional data in real time according to the present invention may further comprise an abdominal electromyogram electrode to be attached to a human body, as a biological signal measuring electrode for detecting influence which a force applied to an abdomen in defecation gives to an defecatio system. In this case, the control unit may compare a pressure value corresponding to a voltage value measured using the abdominal electromyogram electrode with any one of the dynamic pressure value and the static pressure value measured using the rectum inserting catheter, to verify validity of the measured data.

### BRIEF DESCRIPTION OF THE DRAWINGS

FIG. 1A is a structural view schematically illustrating an urodynamics system according to one preferred embodiment of the present invention;

FIG. 1B is a view illustrating a connection relationship between a bladder inserting catheter and a mono-carrier according to one preferred embodiment of the present invention;

FIG. 2A is a view illustrating a detailed configuration of the bladder inserting catheter according to one preferred embodiment of the present invention;

FIG. 2B is a view illustrating a detailed configuration of a rectum inserting catheter according to one preferred embodiment of the present invention;

FIG. 3A is a view illustrating various methods of constructing a data detecting section according to one preferred embodiment of the present invention;

FIG. 3B is a view illustrating a detailed configuration of the data detecting section according to a rear-end construction type;

FIG. 4 is a view illustrating a configuration of a control unit according to one preferred embodiment of the present invention; and

FIG. 5 is a view illustrating a detailed configuration of a residual urine detecting section according to one preferred embodiment of the present invention.

### REFERENCE NUMERALS

105: liquid storage section

110: flow rate adjusting section

115: pumping section

120: liquid distributing section

125: data detecting section

130: bladder inserting catheter

133: mono-carrier

135: rectum inserting catheter

140: control unit

145: abdominal electromyogram electrode

150: flow rate measuring section

155: peripheral units

410: comparison section

415: signal converting section

420: control section

425: motor driving section

430: storage section

### DESCRIPTION OF THE PREFERRED EMBODIMENTS

Now, preferred embodiments of the present invention will be described in detail with reference to the appended drawings.

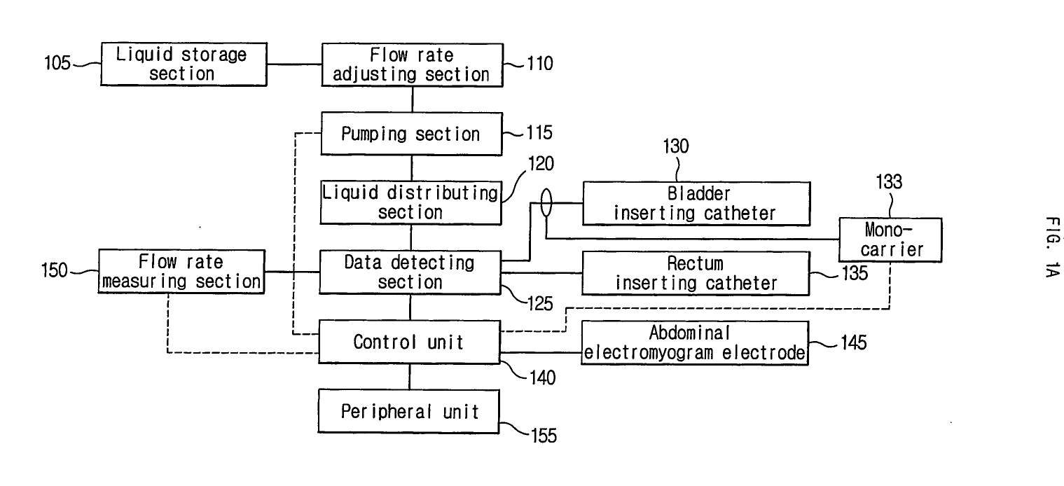

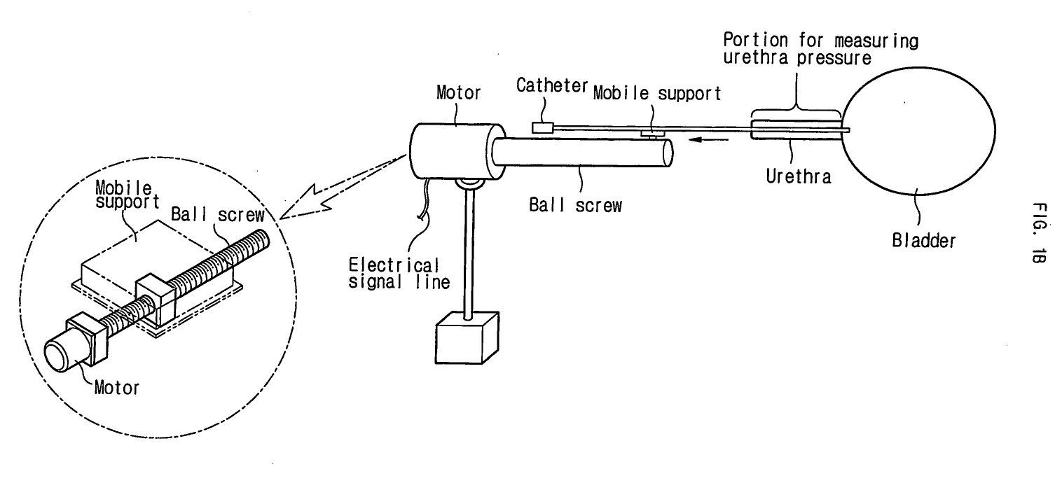

FIG. 1A a structural view schematically illustrating an urodynamics system according to one preferred embodiment of the present invention, and FIG. 1B is a view illustrating a connection relationship between a bladder inserting catheter and a mono-carrier according to one preferred embodiment of the present invention.

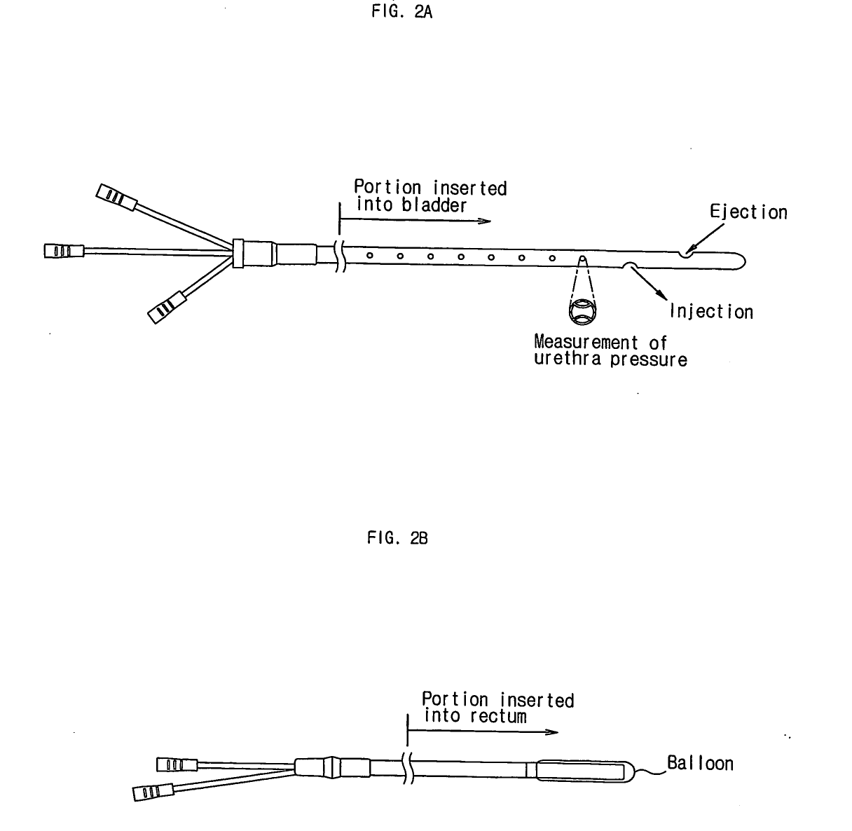

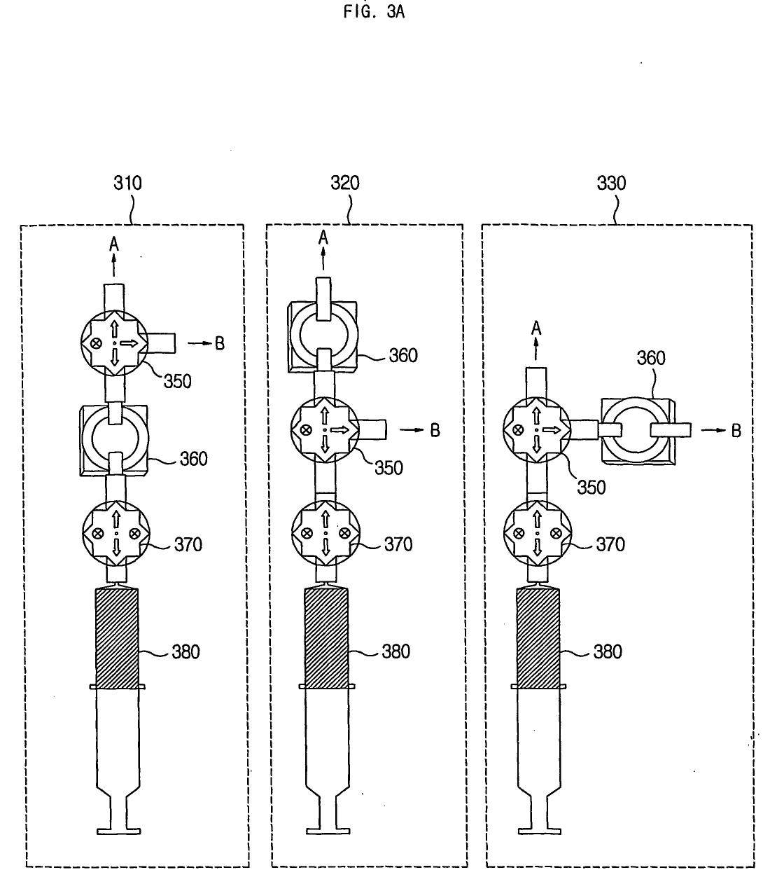

FIG. 2A is a view illustrating a detailed configuration of the bladder inserting catheter according to one preferred embodiment of the present invention, and FIG. 2B is a view illustrating a detailed configuration of a rectum inserting catheter according to one preferred embodiment of the present invention.

Referring to FIG. 1A, the urodynamics system according to the present invention comprises a liquid storage section 105, a flow rate adjusting section 110, a pumping section 115, a liquid distributing section 120, a data detecting section 125, a bladder inserting catheter 130, a mono-carrier 133, a rectum inserting catheter 135, a control unit 140, an abdominal electromyogram electrode 145, a flow rate measuring section 150, and a peripheral unit 155. However, the liquid storage section 105 may be not included in the urodynamics system according to the present invention, but may be coupled to the flow rate adjusting section 110 of the urodynamics system for use.

The liquid storage section 105 is a means for storing a liquid (for example, 0.9% isotonic sodium chloride solution for scrub or disinfection—hereinafter, referred to as a physiological salt solution) used in place of a urine to be stored in a bladder. The amount of the physiological salt solution used at a time in the urodynamics system is based on the volume of bladder. For example, since the volume of bladder of an adult is about 300 to 500 ml, it is preferable that the required physiological salt solution is selected to be about 1000 ml which is two or three times the volume of bladder in consideration of the physiological salt solution lost during inspection. In general, the liquid storage section 105 is fixed for use at a height similar to that of Ringer's solution using a hanger for the purpose of convenience, but since the urodynamics system according to the present invention includes the pumping section 115, a position of the liquid storage section 105 is not limited.

The flow rate adjusting section 110 is used for measuring an urethra pressure. That is, the flow rate adjusting section 110 serves for supplying a very small amount (pressure) of physiological salt solution to the pumping 115, when the urethra pressure is intended to to measured using the pumping section 115 of which a pumping range is set to be a constant range necessary for the bladder or the rectum. For example, a speed adjusting unit of a Ringer's syringe can correspond thereto.

In general, the urodynamics system can measure pressures in the bladder, the urethra and the rectum, but in comparison with a case of measuring the bladder pressure or the rectum pressure, a very small pressure (fluid) is required for measuring the urethra pressure. Therefore, it is not physically possible to solve two problems with one pump because of a limit of a speed adjusting range due to an electrical characteristic of a pump. The flow rate adjusting section 110 can be used for measuring the urethra pressure, even if a pump set to fill and empty the bladder is used.

The pumping section 115 includes a tube, a pump and motor, and is a means for filing the bladder with the physiological salt solution through the bladder inserting catheter 130 by force. Even when the urodynamics system does not include the pumping section 115, the bladder can be filled with the physiological salt solution by fixing the liquid storage section 105 at a position of Ringer's solution, but there is a problem that the filling speed and the filling amount of the physiological salt solution cannot be adjusted properly.

Concrete specifications of the tube, the pump and the motor included in the pumping section 115 according to the present invention can be exemplified as follows.

First, a Marprene II tube or a silicon tube which can be used for foods and drugs and is made of thermoplastic material can be used as the tube. A bore of the tube which determines the ejecting amount may be set to 3.2 mm, and a wall thickness of the tube which determines the force of restoration can be set to 1.6 mm.

Next, as the pump, a peristaltic pump excellent in driving efficiency at a relatively low pressure can be used. This peristaltic pump is sanitary because the liquid passing through the tube can be invasively pumped without any mutual contamination between the liquid to be absorbed and discharged and the pump. In addition, the peristaltic pump has advantages that it is a complete self-priming type, it can idle without damage of the pump, it is operated smoothly to be ideal for discharge of materials sensitive to deformation, and the pump itself performs a function as a check valve (a function of preventing a backflow) in a pause state. The peristaltic pump is operated to repeat absorption, collection and discharge processes in accordance with rotation of a rotor coupled to the motor.

Finally, the motor is not limited to a DC type (12V/24V) motor or an AC type (one phase/three phase) motor, only if it satisfies a proper number of rotations (for example, 1 to 600 rpm) and a proper output torque (for example, 2.8 to 24 kgcm). However, it is preferable that a motor of DC 24V and 30W excellent in safety and controllability is employed.

The liquid distributing section 120 serves for distributing the fluid discharged through the pumping section 115 (that is, one pump) into three paths (that is, two lumens of the bladder inserting catheter 130 and one lumen of the rectum inserting catheter 135). By providing the liquid distributing section 120, it is possible to concurrently send the fluid into three paths with one pump, without providing a pump for each path. In addition, since the 3 lumen catheter can be directly connected to the data detecting section 125, the number of insertions of the catheter into the urethra is decreased in comparison with a case of 1 lumen catheter, so that it is possible to reduce the inspection time as well as alleviate pains of a patient.

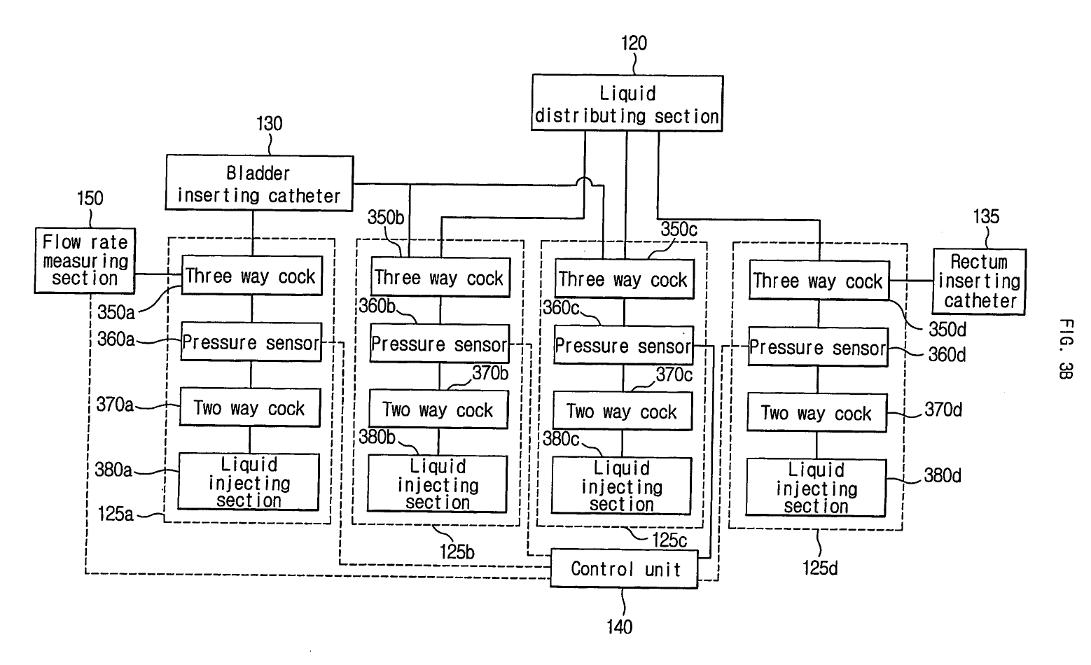

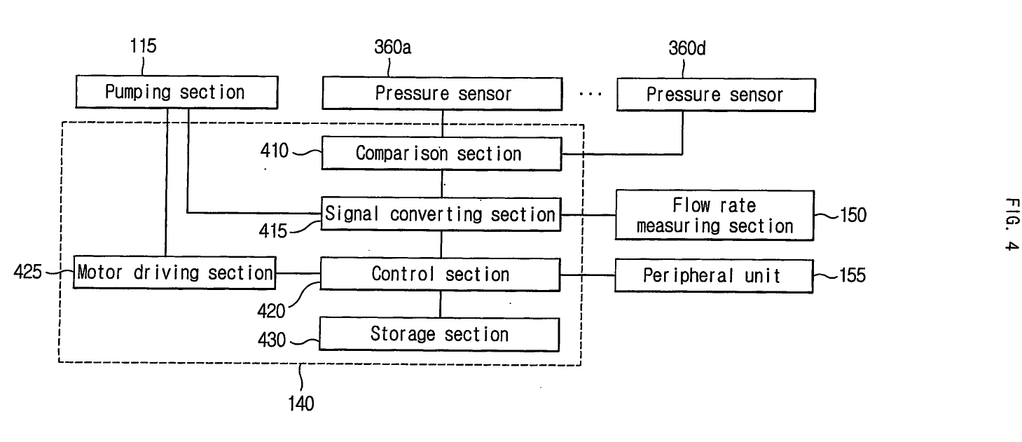

The data detecting section 125 makes it possible to accurately measure data without errors by mutually comparing and verifying the dynamic pressure data and the static pressure data measured in the course of filling the bladder with the physiological salt solution and ejecting the physiological salt solution from the bladder through the bladder inserting catheter 130 and in the course of filling the rectum with the physiological salt solution and ejecting the physiological salt solution from the rectum through the rectum inserting catheter 135 in a state in which the zero points has been adjusted. The detailed configuration of the data detecting section 125 and specific functions of the respective elements thereof will be described in detail later with reference to FIGS. 3A and 3B.

The bladder inserting catheter 130 comprises 3 lumens made of latex-free material, and the inside thereof is filled with the physiological salt solution. The bladder inserting catheter 130 has an end portion round and sharp to facilitate the insertion into the bladder through the urethra, as shown in FIG. 2A. The lumens have a function of filling the bladder with the physiological salt solution, a function of ejecting the physiological salt solution from the bladder, and a function of measuring the urethra pressure, respectively. Since the present invention employs the three lumen catheter capable of measuring the necessary data at one time through one insertion in place of the one lumen catheter used for three insertions into the urethra in the conventional urodynamics system, it is possible to reduce the pains of a patient and reduce the inspection time.

The mono-carrier 133 serves for inserting the bladder inserting catheter 130 into the bladder and pulling out the bladder inserting catheter 130 from the bladder through the urethra. For example, the mono-carrier can be used for measuring the urethra pressure corresponding to the length of urethra using the urethra pressure measuring lumen in the course of pulling out the bladder inserting catheter 130 inserted into the bladder, so that it can be inspected whether the urethra has an disorder or not when eliminating the urine filling in the bladder through the urethra.

First, the pressure distribution measured in the course of inserting the bladder inserting catheter 130 completed the zero point adjustment into the urethra using the mono-carrier 133 is made to be stored as inserting pressure distribution parameters. Thereafter, when the bladder inserting catheter 130 is completely inserted into the bladder, the motor is inversely driven to pull out the bladder inserting catheter 130 fixed to a mobile support using a ball screw from the urethra. In the meantime, the pressures sequentially measured by means of the pressure sensor 360 (see FIGS. 3A and 3B) connected to a rear end of the urethra pressure measuring lumen of the bladder inserting catheter 130 along the urethra path are stored as pulling-out pressure distribution parameters. The inserting pressure distribution parameters and the pulling-out pressure distribution parameters obtained like above indicate characteristics corresponding to the length of urethra, and by comparing the two pressure distribution parameters each other, it is possible to basically perform the verification of data error.

The rectum inserting catheter 135 is inserted into the rectum through the anus to measure the rectum pressure, and as shown in FIG. 2B, the 2 lumen catheter can be applied thereto. If the 2 lumen catheter is used for the rectum inserting catheter 135, it is possible to measure the dynamic pressure and the static pressure and to compare them each other. However, since the rectum inserting catheter 135 has a balloon provided at an end thereof, the rectum inserting catheter 135 may employ an 1 lumen catheter unlike the bladder inserting catheter 130.

In general, since the pressure value measured in the rectum is not required for the urodynamics system, the rectum inserting catheter 135 is omitted in the conventional urodynamics system. However, the urodynamics system according to the present invention comprises the rectum inserting catheter 135 for the purpose of measuring the abdominal pressure. That is, since the rectum pressure is clinically considered to be equal to the abdominal pressure, it is preferable that the rectum pressure having small errors is measured rather than the abdominal pressure having large errors. Further, when the rectum inserting catheter 135 is inserted into the rectum through the anus after the zero point is set on the basis of the atmospheric pressure in a state that the rectum inserting catheter 135 is filled with the physiological salt solution (or in a state that the rectum inserting catheter 135 is filled with air), it can be checked what difference between the pressure value under the atmospheric pressure (that is, before insertion of the catheter) and the pressure value after the catheter is inserted into the rectum (including the inserting process) is, so that it is possible to accomplish accuracy of the inspection.

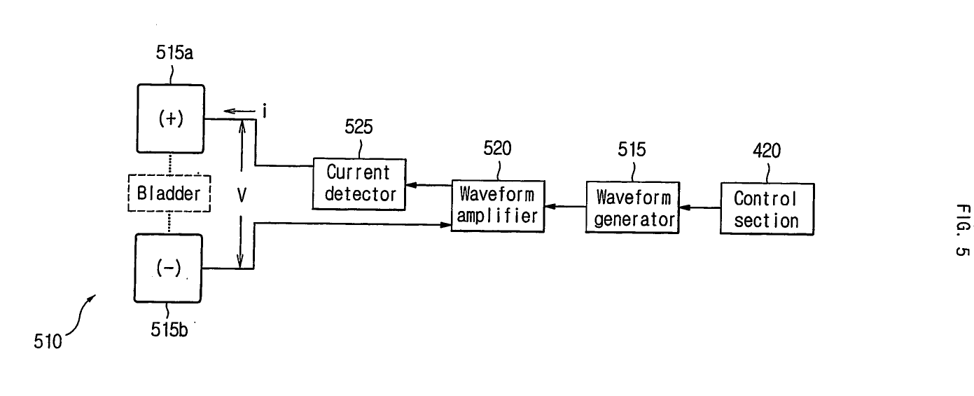

In order to accurately detect the urination disorder of a patient using the urodynamics system according to the present invention, the control unit 140 controls the flow rate adjusting section 110, the pumping section 115, the liquid distributing section 120, the data detecting section 125, the bladder inserting catheter 130, the mono-carrier 133, the rectum inserting catheter 135, the abdominal electromyogram electrode 145, the flow rate measuring section 150 and the peripheral units 155, and in addition, the control unit 140 performs a function of checking whether the data detected by the data detecting section 125 is valid or not. The detailed configuration of the control unit 140 will be described later with reference to FIG. 4.

The abdominal electromyogram electrode 145 is a biological signal measuring electrode used for finding out what influence is given to the urination system from abdominal operations. That is, the abdominal electromyogram electrode 145 is a biological signal measuring electrode attached to the abdomen of a patient so as to find out what influence is given to the urination system (specifically, the bladder right below the abdomen) by force acting on the abdomen when a patient executes the urination action. The abdominal electromyogram electrode 145 according to the present invention has a metal and an electrolyte forming polarities thereof, and further has an adhesive plaster shape being attached to a human body.

Since a biological potential/voltage measured through the abdominal electromyogram electrode 145 can be converted into pressure value (H2O-cm) using Oxford's table, the dimension thereof is unified with that of various pressure values obtained from the urodynamics system, so that the relationship therebetween can be analyzed. However, since errors can be generated in this case, for the purpose of verification thereof, the urodynamics system according to the present invention comprises the rectum inserting catheter 135 capable of measuring the rectum pressure clinically considered as equal to the abdominal pressure. The electromygram potential and the pressure have a constant relationship, even in a singular case that the rectum pressure and the abdominal pressure are not equal each other. Therefore, when the abdominal electromygram electrode 145 and the rectum inserting catheter 135 are used together, a force (pressure) acting on the abdomen can be obtained within a relatively small range of error, by measuring a biological abdominal signal having an absolute value from the electromyogram potential and then converting the signal into pressure.

In general, signals are differentially amplified for the purpose of removing common mode noise in measuring the biological signals through the abdominal electromyogram electrode 145. That is, a plus (+) potential and a minus (−) potential are measured with respect to a ground, only the signals having phases other than the same phase are measured, and then difference between the two signals is obtained. Therefore, three abdominal electromyogram electrodes (145) including a plus (+) potential electrode, a minus (−) potential electrode and a ground (GND) electrode are attached to the abdomen as one set, the plus (+) signal and the minus (−) signal are differentially amplified with respect to the ground (GND) electrode and linearly amplified through a filter. Therefore, the electromygram signals can be easily observed with a naked eyes. In the urodynamics system according to the present invention, the signals amplified through the linear amplifier are supplied to the control unit 140. Of course, the control unit 140 may supply functions of the differential amplification, the filtering and the linear amplification for the abdominal electromygram electrode 145.

The flow rate measuring section 150 is a means for measuring an amount of physiological salt solution eliminated from the bladder or an amount of residual urine, when the physiological salt solution injected into the bladder is eliminated naturally or through one lumen of the bladder inserting catheter 130, and a circuit thereof as a kind of flowmeter can be constructed similarly to the pressure sensor. For example, a sensor to be used as the flowmeter includes a load cell, a rotating disc, a turbine, etc. The load cell having a high accuracy, a low cost and a high reliability is designed into a special strain gauge constructed simply for measuring the elimination amount (weight) of urine, and has an advantage that it is possible to accurately measure the elimination amounts of urine different every persons.

The peripheral units 155 can include all the user interface means for allowing a user to control the control unit 140, such as a monitor, a keyboard (or keypad), a printer, a remote controller, a storage section and so on.

FIG. 3A is a view illustrating various methods of constructing the data detecting section according to one preferred embodiment of the present invention, FIG. 3B is a view illustrating a detailed configuration of the data detecting section according to a rear-end construction type, and FIG. 4 is a view illustrating a configuration of the control unit according to one preferred embodiment of the present invention.

FIG. 3A is a view illustrating various methods of constructing the data detecting section 125 in the urodynamics system according to the present invention.

The data detecting section 125 according to the present invention a three way cock 350, a pressure sensor 360, a two way cock 370 and a liquid injecting section 380, and can have various configurations as shown in FIG. 3A.

Before describing features of the respective configurations shown in FIG. 3A, functions and features of the respective means included in the data detecting section 125 will be described.

The three way cock 350 is used for changing the path of the fluid supplied from the liquid distributing section 120 or stopping the flow through a specific path.

The connecting relationship of the three way cock 350 will be described using the rear-end construction type 310 shown in FIG. 3A. First, “A” is connected to the fluid distributing section, “B” is connected to a catheter (that is, a lumen of the bladder inserting catheter 130 or the rectum inserting catheter 135), and the remaining one lumen is connected to the pressure sensor 360. Like this, when the data detecting section 125 is constructed in the rear-end construction type 310, the fluid originated from the pump is charged into the bladder through the catheter connected to the “B” lumen through the fluid distributing section (that is, through the “A” path), and in the meantime, the pressure (that is, dynamic pressure) is measured by the pressure sensor 360. That is, when paths are formed in the three directions by means of adjustment of a grip, the pressure sensor 360 measures a pressure of the fluid through the lumens between “A” and “B”. The mode of rotating the grip of the three way cock 350 includes a manual mode and an electronic mode.

Like above, when the three way cock 350 is used in the urodynamics system according to the present invention, the pressure of the bladder can be measured in the course of filling the bladder with the fluid pumped by the pump through the catheter.

The pressure sensor 360 serves for measuring the static pressure and the dynamic pressure alternately, and can adapt a solid-state pressure sensor of a piezoresistance type. The solid-state pressure sensor is a sensor of measuring the pressure of the fluid passing through a Venturi tube and detecting the pressure electronically by use of Bernoulli's equation. This solid-state pressure sensor very rapidly responds to variation in pressure, and employs a method of measuring difference in pressure. Since one of two pressures measured by the solid-state pressure sensor is exposed to a local atmospheric pressure, the measured pressure indicates a relative pressure to the local atmospheric pressure.

On the contrary, the conventional urodynamics system employs the strain gauge method for measuring the pressure. This method is a method of measuring variation in electric resistance due to displacement of an elastic membrane resulting from variation in pressure in a strain gauge having a rhombic shape made of a very thin line of which the electric resistance is varied in its expansion. However, this method is intended to measure only any one of the static pressure and the dynamic pressure, and thus is different from the method of concurrently measuring the dynamic pressure and the static pressure in the urodynamics system according to the present invention.

Now, the method of measuring the dynamic pressure and the static pressure in the solid-state pressure sensor will be described in brief.

In the solid-state pressure sensor, a sensor is positioned such that the dynamic pressure and the static pressure of the fluid passing through the Venturi tube can be measured, and then the relevant parameters are obtained by adapting Bernoulli's equation to the fluid.

The static pressure can be easily measured using a manometry method in which a liquid pillar is built to measure the pressure.

However, in a case of dynamic pressure, it is supposed that an initial pressure at an inlet of the Venturi tube is P1, a central pressure at the least width is P2 and an outlet pressure is P3. Then, a most dropped pressure is measured by the solid-state pressure sensor. In this case, the pressure difference between the initial pressure P1 at the inlet and the diffused pressure P3 corresponds to the total pressure drop.

Furthermore, when the pressure is measured by the solid-state pressure sensor, a flow rate and a volume at any time interval can be calculated using the known arithmetic equation, and other Theological parameters can be further calculated.

That is, the urodynamics system according to the present invention can not only check whether the relevant measured values are valid or not by comparing in real time the pressure value by the dynamic pressure (path) sensor and the pressure value by the static pressure (path) sensor obtained using the aforementioned method, but also can consider the errors of the obtained data and verify whether the measured values are valid or not by sequentially obtaining the flow rate, the volume and the weight from the respective measured pressure values and mutually comparing them.

For example, the bladder inserting catheter 130 comprises a physiological salt solution inserting lumen (for example, lumen 1) and a physiological salt solution ejecting lumen (for example, lumen 2) separately, and the respective lumens are coupled to respective pressure sensors (for example, pressure sensor 1 and pressure sensor 2). Therefore, in the course of filling the bladder with the physiological salt solution through lumen 1, pressure sensor 1 measures the dynamic pressure, pressure sensor 2 coupled to lumen 2 measures the static pressure in the bladder, and the control unit 140 compares the measured dynamic pressure and static pressure each other to verify the measured pressure value (see FIG. 3B and FIG. 4). Of course, in the course of discharging the physiological salt solution filling in the bladder, processes inverse thereto are carried out.

Furthermore, in the urodynamics system according to the present invention, when the weight of the discharged physiological salt solution is measured by the flow rate measuring section 150, the volume, the flow rate and the pressure can be concurrently calculated and the respective parameter values can be compared, inversely, so that it is further possible to mutually verify data in real time.

However, since the conventional method employs only any one of the dynamic pressure (path) sensor and the static pressure (path) sensor, the conventional method has an advantage that it is low in production cost, but the conventional method has a disadvantage that it does not satisfy acquisition of accurate data which is most important in medical implements. That is, the conventional method has a disadvantage that it is not possible to perform the mutual comparison or the data verification due to non-existence of a reference value, because the conventional method uses only one measuring method such as a method in which the pressure is measured by means of the dynamic pressure (path) sensor or the static pressure (path) sensor and then the flow rate, the volume and the weight are sequentially calculated, or a method in which the weight is measured by means of the flowmeter and then the volume, the flow rate and the pressure are sequentially calculated.

The two way cock 370 comprises a single lumen, and is an open-and-shut valve capable of making and breaking the two way flow. In the urodynamics system according to the present invention, the two way cock is used for first making the fluid to perform a zero-point adjustment and then breaking the flow to maintain the zero point. The two way cock 370 can be used as an auxiliary means for accurately measuring data, and may be used selectively as needed.

The liquid injecting section 380 serves for performing physical correction when the zero point of the pressure sensor 360 is adjusted or when measurement errors are generated. For example, a syringe can be used as the liquid injecting section 380, and the same as the liquid (for example, physiological salt solution) stored in the liquid storage section 105 is used as an injection liquid for the liquid injecting section 380. For example, when the pumping is performed for the purpose of preparation before filling the bladder with the physiological salt solution, the pressure condition for the previous inspection and the pressure condition for the current inspection are not accurately equal to each other. Therefore, the liquid injecting section 380 can be used for adjusting the initial pressure value to be equal to the previous initial pressure value. Furthermore, the liquid injecting section 380 can be used for temporarily maintaining a small pressure such as the urethra pressure or for compulsorily and rapidly ejecting the residual urine remaining in the bladder.

Referring to FIG. 3A, various configurations of the data detecting section 125 comprising the three way cock 350, the pressure sensor 360, the two way cock 370 and the liquid injecting section 380 are exemplified.

That is, the construction types of the data detecting section 125 can include a rear-end construction type 310, a front-end construction type 320, the terminal-end construction type 330, depending upon a position of the pressure sensor 360 about the three way cock 350.

The respective construction types have common points that the pressure sensor can measure the pressure of the fluid flowing through path A and path B and that the measured pressure values are not different each other when diameters of the lumens are not largely different. However, in a case of measuring the dynamic pressure, the front-end construction type 310 and the terminal-end construction type 330 have a direct influence on the dynamic pressure. Whereas, since the rear-end construction type 310 can measure the dynamic pressure in the same manner as measuring the static pressure, it is possible to obtain data more stably using the rear-end construction type. Therefore, a case that the data detecting section 125 of the urodynamics system according to the present invention employs the rear-end construction type 310 will be now described mainly.

FIG. 3B is a view illustrating a detailed configuration of the data detecting section employing the rear-end construction type.

The data detecting section 125 of the urodynamics system according to the present invention comprises one set of four measuring modules 125a, 125b, 125c and 125d constructed in the rear-end construction type 310 (see FIG. 3A). The measuring modules 125a, 125b, 125c and 125d comprise the three way cocks 350a, 350b, 350c and 350d, the pressure sensors 360a, 360b, 360c and 360d, the two way cocks 370a, 370b, 370c and 370d, and the liquid injecting sections 380a, 380b, 380c and 380d, respectively. However, as described above, the two-way cocks 370a, 370b, 370c and 370d can be omitted.

The pressure sensors 360a, 360b, 360c and 360d of the respective measuring modules are coupled to the control unit 140, and are controlled by the control section 420 (see FIG. 4), respectively, so that the pressure measurement of the fluid is possible.

A first three way cock 350a of a first measuring module 125a is connected to the flow rate measuring section 150, a first pressure sensor 360a, and the physiological salt solution ejecting lumen of the bladder inserting catheter 130. Further, a second three way cock 350b of a second measuring module 125b is connected to the liquid distributing section 120, a second pressure sensor 360b, and the physiological salt solution injecting lumen of the bladder inserting catheter 130. Furthermore, a third three way cock 350c of a third measuring module 125c is connected to the liquid distributing section 120, a third pressure sensor 360c, and the urethra pressure measuring lumen of the bladder inserting catheter 130. Furthermore, a fourth three way cock 350d of a fourth measuring module 125d is connected to the liquid distributing section 120, a fourth pressure sensor 360d, and the rectum inserting catheter 135.

The urodynamics system according to the present invention has an advantage that it can be used for the purpose of measuring various pressure values (that is, the static pressure and the dynamic pressure), regardless of the number of catheter lumens (the number of channels), the kind of catheter corresponding to use of insertion, and use of the respective lumens (that is, use of the physiological salt injecting lumen or the physiological salt solution ejecting lumen). Now, a method of extracting the required data using the four measuring modules in the data detecting section 125 will be described in brief.

As described above, in the urodynamics system according to the present invention, the three lumen (channel) catheter is used for the bladder inserting catheter 130 to detect all the required data with one insertion of a catheter. Further, the urodynamics system according to the present invention employs a one lumen catheter as the rectum inserting catheter 135 for measuring the rectum pressure acting similarly to the abdominal pressure to measure the abdominal pressure of a patient, and further comprises the abdominal electromyogram electrode 145 for the purpose of verification and correction of the abdominal pressure. However, since the rectum inserting catheter 135 uses static fluid/air as a target unlike the bladder inserting catheter 130, the rectum inserting catheter 135 has a balloon shaped end and has a manometry characteristic.

In addition, the pressure sensors 360a, 360b, 360c and 360d are connected to the respective lumens of the respective catheters, the pressure sensors 360a, 360b, 360c and 360d are also connected to the zero-point adjusting means (that is, the liquid injecting sections 380a, 380b, 380c and 380d). The control section 420 (see FIG. 4) supplies functions of differential amplification, filtering and linear amplification for the abdominal electromyogram electrode 145.

Furthermore, the physiological salt solution is used as the liquid injected and ejected through the catheter, and in a case of the bladder inserting catheter 130, the mono-carrier may be further comprised, in which the pressure value can be basically measured while slowly pulling out the catheter inserted into the bladder for the needed purpose (for example, for the purpose of measuring the urethra pressure).

The conventional urodynamics system employed a static pressure detecting method in which the pressure sensor is connected only to the physiological salt solution ejecting lumen. That is, when filling the bladder with the physiological salt solution, the physiological salt solution ejecting lumen is closed and the static pressure is measured using the pressure sensor until the bladder is full of the physiological salt solution. However, in such urodynamics system, it is very difficult to verify errors due to the sensors having high probability of generating self errors, and it is inherently impossible to objectively verify the errors.

On the contrary, the urodynamics system according to the present invention employs as the pressure sensor the solid-state pressure sensor capable of concurrently the static pressure and the dynamic pressure, and the respective pressure sensors 360 are connected to the physiological salt solution injecting lumen and the physiological salt solution ejecting lumen to verify the errors of the measured pressure values. Therefore, even when the physiological salt solution injecting lumen and the physiological salt solution ejecting lumen are exchanged by mistake, it is possible not to have adverse effects on the measured data or the urodynamics system.

That is, in the course of injecting the physiological salt solution, the second pressure sensor 360b attached to the physiological salt solution injecting lumen measures the dynamic pressure, and at the same time, the first pressure sensor 360a attached to the physiological salt solution ejecting lumen measures the static pressure. In addition, the control section 420 (see FIG. 4) compares the static pressure and the dynamic pressure measured by the first pressure sensor 360a and the second pressure sensor 360b, respectively, in real time to verify whether the relevant measured values are valid or not. Of course, if both values are not valid, the process such as adjustment of zero point should be carried out.

On the contrary, in the course of ejecting the physiological salt solution, the first pressure sensor 360a attached to the physiological salt solution ejecting lumen measures the dynamic pressure, and at the same time, the second pressure sensor 360b attached to the physiological salt solution injecting lumen measures the static pressure. In addition, the control section 420 (see FIG. 4) compares the dynamic pressure and the static pressure measured by the first pressure sensor 360a and the second pressure sensor 360b, respectively, in real time to verify whether the relevant measured values are valid or not.

At that time, the flow of the physiological salt solution in the lumen can be adjusted through the three way cock 350. Like this, the urodynamics system according to the present invention can objectively detect the system error or errors by comparing the measured pressure values in real time.

In addition, even when the urethra pressure is measured using the urethra pressure measuring lumen included in the bladder inserting catheter 130, the urodynamics system according to the present invention measures all the pressure distributions in inserting and pulling out the bladder inserting catheter 130 through the urethra, and mutually compares the measured data. Therefore, it is possible to solve the problem that the measured values in the conventional urodynamics system are uncertain by measuring the pressure distributions only in the course of pulling out the mono-carrier.

Like above, in the urodynamics system according to the present invention, it is possible to verify the measured pressure values, and at the same time, to accurately detect the relationship between the pressure variations corresponding to the filing and the voiding of the bladder.

Furthermore, the conventional urodynamics system employed an electrical reset method of setting up the zero-point on the basis of the local pressure. That is, in the electrical reset method, regardless of how the initial pressure is with respect to the atmospheric pressure, the initial pressure is considered as zero (0), and the pressure applied from that time is relatively measured.

However, since this pressure setting-up method ignores the principle that all the physiological phenomena occur with respect to the atmospheric pressure, the accurate analysis cannot be carried out. On the other hand, since the zero-point adjustment in the conventional urodynamics system is carried out electrically, it is impossible to solve the above problem.

Therefore, the zero-point adjustment is mechanically carried out in the urodynamics system according to the present invention. That is, a reference point is set as a physical zero potential, not as an electrical zero potential.

That is, in the conventional urodynamics system, the zero point is set up on the basis of an inner state of the bladder after the catheter is inserted into the bladder and before the physiological salt solution is injected into the bladder, while in the urodynamics system according to the present invention, the inner state of the bladder is initially set up under the atmospheric condition, and then continuous variation in pressure can be measured from a time point when the catheter is inserted into the urethra to a time point when the catheter reaches the bladder, and in the course of filling the bladder with the physiological salt solution by means of the pump.

A detailed configuration of the control unit 140 for verifying whether the data detected from the pressure sensor 360, the flow rate measuring section 150, etc. is valid or not is shown in FIG. 4.

Referring to FIG. 4, the control unit 140 comprises a comparison section 410, a signal converting section 415, a control section 420, a motor driving section 425, and a storage section 430.

The comparison section 410 performs a function of mutually comparing the respective pressure values measured by the respective pressure sensors 360a, 360b, 360c and 360d (hereinafter, referred to as 360) in the course of filling the physiological salt solution or in the course of ejecting the physiological salt solution. However, the comparison section 410 may be omitted as needed, and the function of the comparison section 410 may be performed by the control section 420.

The signal converting section 415 performs a function of receiving the result of comparison by the comparison section 410, the driving state of the motor included in the pumping section 115 and the result of flow rate measurement by the flow rate measuring section 150 and transmitting them the control unit 420, and at that time, may further perform a function of converting analog signals into digital signals and a counting function, etc.

The control section 420 inspects the validity of the pressure value measured by the pressure sensor 360 using the data received through the signal converting section 415, and performs the zero point adjustment of the pressure sensor 360 and the driving state change of the motor, etc., in accordance with the inspection result. The control section 420 may comprise a micro controller or the like.

The motor driving section 425 performs a function of changing the driving state of the motor included in the pumping section 115 in accordance with control of the control section 420. For example, in the conventional urodynamics system, the physiological salt solution is injected at a constant speed when injecting the physiological salt solution after insertion of the catheter through the urethra. However, since the bladder is full of the physiological salt solution within a shorter time than that in a natural state, a patient feels violent pains. Therefore, in order to reduce the pains of the patient, it is important that the physiological salt solution to be injected should be pumped rapidly at the first time and slowly later, and such function is performed by the motor driving section 425 on the basis of the control of the control section 420.

Further, the storage section 430 performs a function of storing operation programs for performing the function of the control section 420 and inspection data of a patient, and may include a general memory means such as RAM, ROM, flash memory or the like.

Furthermore, although not shown in FIG. 4, the control unit may further comprise a power source input section.

Like above, the urodynamics system according to the present invention is characterized in that the driving signals required for driving the motor can be generated using the electrical signal (processing) control method and the pressures of plural systems can be measured to continuously monitor the difference thereof in real time through the comparison section 410.

FIG. 5 is a view illustrating a detailed configuration of the residual urine detecting section according to one preferred embodiment of the present invention.

The most urinary incontinence of the urination disorders can be said to be a clinical symptom of a storage disorder except for overflow, and the residual urine is a very important clinical index in a case of the elimination disorder.

The residual urine detecting section 510 performs a function of calculating the amount of residual urine remaining in the bladder of a patient by obtaining impedance due to a flowing current using an electrical stimulation (EST) function. Referring to FIG. 5, the residual urine detecting section 510 comprises the control section 420, a waveform generator 515, a waveform amplifier 520, a current detector 525 and electrodes 515a, 515b.

As electrode A 515a and electrode B 515b, inserting electrodes such as an anal electrode as well as the patch electrode such as the abdominal electromyogram electrode 145 can be used. The electrode A 515a and the electrode B 515b can be arranged regardless of kinds of the electrodes, but they should be arranged at positions where a current i can flow through the bladder as a whole.

Operations of the residual urine detecting section 510 will be described with reference to FIG. 5. According to an instruction input by a user or a predetermined operating algorithm, the control section 420 (or may be a separate signal processing control unit) allows the waveform generator 515 to generate a pulse waveform, the generated pulse waveform is amplified into a waveform having a predetermined size by the waveform amplifier 520, and then the current detector 525 allows a current to flow through the electrode A 515a, the bladder and the electrode B 515b. At that time, a voltage V applied between the electrode A 515a and the electrode B 515b connected in parallel to both output terminals of the waveform amplifier 520 and a current flowing in the current detector 525 connected in series to the electrodes are measured, the impedance value which is varied correspondingly to the amount of residual urine in the bladder can be calculated using a known arithmetic equation. In this case, as a signal of the applied voltage V, a sinusoidal wave of 1 to 100V and 1 to 50 kHz adjusted such that a range of the current flowing in the current detector 525 falls within a range of 0.1 to 1 mA can be used.

According to the aforementioned method, the residual urine detecting section 510 can calculate the residual urine in the bladder, and by comparing the calculated residual urine with the flow rate (that is, the amount of urine initially ejected through the bladder inserting catheter 130) measured by the flow rate measuring section 150, it is possible to easily verify the validity of data.

Although it has been mainly described that the urodynamics system according to the present invention applies to inspection of the urination disorder corresponding to the urinary incontinence or the urinary frequency, the urodynamics system according to the present invention can also apply to a case of inspecting a defecation disorder such as a constipation and feces incontinence.

That is, using the same principle as the bladder inserting catheter, the rectum inserting catheter, having the same shape as the bladder inserting catheter 130 and having a large diameter and poly lumens, is inserted into the rectum through the anus, and then by measuring the pressure distribution in accordance with the length of the rectum/anus while pulling out the rectum inserting catheter, the obstruction disorder of rectum/anus can be diagnosed. For example, if the degree of obstruction is large, it is judged to be a constipation, and if the degree of obstruction is small, it is judged to be a feces incontinence. However, since the method of judging the defecation disorder using the rectum inserting catheter has the same principle as the method of judging the urination disorder using the bladder inserting catheter, explanation thereof will be omitted.

The present invention is not limited to the aforementioned embodiments, but it will be understood by those skilled in the art that various changes or modifications may be made thereto without departing from the spirit and scope of the invention.

### INDUSTRIAL AVAILABILITY

In the method and the apparatus for verifying data measured by several means in real-time according to the present invention, it is possible to minimize pains of a patient and the inspection time, by detecting all the required data with one insertion of a catheter to allow all the inspecting processes to be completed.

Further, according to the present invention, it is possible to provide a function of verifying errors or adjusting a zero point for reduction of errors, by employing the bidirectional data detecting method and allowing data measured in real time to be compared mutually.

Furthermore, it is possible to maintain certainty and consistency of the measured data by means of the verification function by the mutual comparison of the measured data and the zero-point adjustment function.

What is claimed is:

1. An urodynamics system having a function of verifying bidirectional data in real time, in which urination disorder of a bladder is diagnosed in the course of filing the bladder with a liquid and ejecting the liquid from the bladder, the system comprising:
a bladder inserting catheter having three or more lumens and being inserted into the bladder through an urethra to fill the bladder with the liquid and eject the liquid from the bladder, wherein the three or more lumens including at least a liquid injecting lumen, a liquid ejecting lumen and an urethra pressure measuring lumen;
a liquid distributing section for distributing the liquid into at least any one of the liquid injecting lumen and the urethra pressure measuring lumen;
a pumping section having a tube, a pump and a motor, for supplying the liquid to the liquid distributing section;
a data detecting section provided between the bladder inserting catheter and the liquid distributing section, for detecting pressure data measured using the respective lumens of the bladder inserting catheter, wherein the data detecting section having pressure sensors connected to the corresponding lumens; and
a control unit for verifying validity of the pressure data detected by the data detecting section, and controlling the pumping section and the data detecting section in accordance with a result of the validity verification or an instruction input by a user.

2. An urodynamics system having a function of verifying bidirectional data in real time according to claim 1, wherein the liquid is a physiological salt solution for scrub or disinfection.

3. An urodynamics system having a function of verifying bidirectional data in real time according to claim 1, wherein in the course of filling the bladder with the liquid through the liquid injecting lumen, the data detecting section measures a dynamic pressure value in the liquid injecting lumen using a first pressure sensor connected to the liquid injecting lumen, measures a static pressure value in the bladder using a second pressure sensor connected to the liquid ejecting lumen, and supplies the dynamic pressure value and the static pressure value to the control unit,
wherein in the course of ejecting the liquid filling in the bladder through the liquid ejecting lumen, the data detecting section measures the dynamic pressure value in the liquid ejecting lumen using the second pressure sensor connected to the liquid ejecting lumen, measures the static pressure value in the bladder using the first pressure sensor connected to the liquid injecting lumen, and supplies the dynamic pressure value and the static pressure value to the control unit, and
wherein the control unit compares the dynamic pressure value and the static pressure value to verify the validity of the measured data.

4. An urodynamics system having a function of verifying bidirectional data in real time according to claim 3, wherein the data detecting section comprises a liquid injecting section for injecting a liquid equal to the liquid for adjustment of zero point when the zero points of the first pressure sensor and the second pressure sensor are not equal to each other.

5. An urodynamics system having a function of verifying bidirectional data in real time according to claim 1, further comprising a rectum inserting catheter of which an end portion is coupled to a sealed balloon and which is inserted into a rectum through the anus for measuring a rectum pressure,
wherein the liquid distributing section further distributes the liquid into the rectum inserting catheter, and
wherein the data detecting section is provided between the rectum inserting catheter and the liquid distributing section, and further detects a pressure data measured by the rectum inserting catheter.

6. An urodynamics system having a function of verifying bidirectional data in real time according to claim 5, further comprising an abdominal electromyogram electrode to be attached to a human body, as a biological signal measuring electrode for detecting influence which a force applied to an abdomen in urination gives to an urination system,
wherein the control unit compares a pressure value corresponding to a voltage value measured using the abdominal electromyogram electrode with the rectum pressure measured using the rectum inserting catheter, and verifies validity of the measured data.

7. An urodynamics system having a function of verifying bidirectional data in real time according to claim 1, further comprising a flow rate adjusting section provided at a front stage of the pumping section, for supplying a small amount of the liquid to the pumping section, in order to measure an urethra pressure using the urethra pressure measuring lumen.

8. An urodynamics system having a function of verifying bidirectional data in real time according to claim 1, further comprising a mono-carrier connected to the bladder inserting catheter, for inserting or pulling out the bladder inserting catheter through the urethra at a constant speed.

9. An urodynamics system having a function of verifying bidirectional data in real time according to claim 1, further comprising a flow rate measuring section for measuring an amount of residual urine or physiological salt solution ejected from the bladder when the residual urine in the bladder or the physiological salt solution filling in the bladder is ejected through the liquid ejecting lumen.

10. An urodynamics system having a function of verifying bidirectional data in real time according to claim 9, further comprising a residual urine detecting section in which a current flowing through a first electrode, the bladder and a second electrode flows,
wherein the control unit calculates the amount of residual urine in the bladder using a magnitude of the current flowing through the first electrode, the bladder and the second electrode and an impedance value calculated from a potential difference between the first electrode and the second electrode, and compares the amount of residual urine with a flow rate measured by the flow rate measuring section to verify the validity of the measured data.

11. A method of verifying in real time bidirectional data in an urodynamice system for diagnosing urination disorder of a bladder in the course of filling the bladder with a liquid and ejecting the liquid from the bladder, the urodynamics system comprising a bladder inserting catheter, a data detecting section and a control unit, the data detecting section having one or more pressure sensors, the method comprising:
a step of filling the bladder with the liquid through a liquid injecting lumen of the bladder inserting catheter inserted into the bladder through an urethra, the bladder inserting catheter having at least the liquid injecting lumen, a liquid ejecting lumen and an urethra pressure measuring lumen;
a step in which a first pressure sensor connected to the liquid injecting lumen measures a dynamic pressure value in the liquid injecting lumen and transmits the dynamic pressure value to the control unit, in the course of filing the bladder with the liquid;
a step in which a second pressure sensor connected to the liquid ejecting lumen measures a static pressure value in the bladder and transmits the static pressure value to the control unit, in the course of filling the bladder with the liquid;
a step in which the control unit compares the dynamic pressure value with the static pressure value to verify validity of the measured pressure value; and
a step of displaying a result of the validity verification in a display section.

12. A method of verifying bidirectional data in real time according to claim 11, further comprising:
a step of ejecting the liquid filling in the bladder through the liquid ejecting lumen;
a step in which the first pressure sensor connected to the liquid injecting lumen measures the static pressure value in the bladder and transmits the static pressure value to the control unit, in the course of ejecting the liquid from the bladder;
a step in which the second pressure sensor connected to the liquid ejecting lumen measures the dynamic pressure value in the liquid ejecting lumen and transmits the dynamic pressure value to the control unit, in the course of ejecting the liquid from the bladder;
a step in which the control unit compares the dynamic pressure value with the static pressure value to verify validity of the measured pressure value; and
a step of displaying a result of the validity verification in a display section.

13. A method of verifying bidirectional data in real time according to claim 11, wherein the urodynamics system further comprises a rectum inserting catheter of which an end portion is coupled to a sealed balloon and which is inserted into a rectum through an anus for measuring a rectum pressure, and an abdominal electromyogram electrode to be attached to a human body, as a biological signal measuring electrode for detecting influence which a force applied to an abdomen in urination gives to an urination system,
the method further comprising:
a step in which a third pressure sensor connected to the rectum inserting catheter inserted through the anus measures the rectum pressure and transmits the rectum pressure to the control unit;
a step in which the control unit compares a pressure value corresponding to a voltage value measured using the abdominal electromyogram electrode with the rectum pressure to verify validity of the measured data; and
a step of displaying a result of the validity verification in a display section.

14. A method of verifying bidirectional data in real time according to claim 11, wherein the urodynamics system further comprises a flow rate measuring section for measuring an amount of residual urine or physiological salt solution ejected from the bladder when the residual urine in the bladder or the physiological salt solution filling in the bladder is ejected through the liquid ejecting lumen, and a residual urine detecting section in which a current flowing through a first electrode, the bladder and a second electrode flows,
the method further comprising:
a step in which the control unit calculates the amount of residual urine in the bladder using a magnitude of the current flowing through the first electrode, the bladder and the second electrode and an impedance value calculated from a potential difference between the first electrode and the second electrode;
a step in which the control unit compares the amount of residual urine with a flow rate measured by the flow rate measuring section to verify validity of the measured data; and
a step of displaying a result of the validity verification in a display section.

15. A defecation disorder diagnosing apparatus having a function of verifying bidirectional data in real time, in which defecation disorder is diagnosed in the course of filling a rectum with a liquid and ejecting the liquid from the rectum, the apparatus comprising:
a rectum inserting catheter having three or more lumens and being inserted into the rectum through an anus to fill the rectum with the liquid and eject the liquid from the rectum, wherein the three or more lumens including at least a liquid injecting lumen, a liquid ejecting lumen and an urethra pressure measuring lumen;
a liquid distributing section for distributing the liquid into at least any one of the liquid injecting lumen and the urethra pressure measuring lumen;
a pumping section having a tube, a pump and a motor, for supplying the liquid to the liquid distributing section;
a data detecting section provided between the rectum inserting catheter and the liquid distributing section, for detecting pressure data measured using the respective lumens of the rectum inserting catheter, wherein the data detecting section having pressure sensors connected to the corresponding lumens; and
a control unit for verifying validity of the pressure data detected by the data detecting section, and controlling the pumping section and the data detecting section in accordance with a result of the validity verification or an instruction input by a user.

16. A defecation disorder diagnosing apparatus having a function of verifying bidirectional data in real time according to claim 15, wherein in the course of filling the rectum with the liquid through the liquid injecting lumen, the data detecting section measures a dynamic pressure value in the liquid injecting lumen using a first pressure sensor connected to the liquid injecting lumen, measures a static pressure value in the rectum using a second pressure sensor connected to the liquid ejecting lumen, and supplies the dynamic pressure value and the static pressure value to the control unit,
wherein in the course of ejecting the liquid filling in the rectum through the liquid ejecting lumen, the data detecting section measures the dynamic pressure value in the liquid ejecting lumen using the second pressure sensor connected to the liquid ejecting lumen, measures the static pressure value in the rectum using the first pressure sensor connected to the liquid injecting lumen, and supplies the dynamic pressure value and the static pressure value to the control unit, and
wherein the control unit compares the dynamic pressure value with the static pressure value to verify validity of the measured data.

17. A defecation disorder diagnosing apparatus having a function of verifying bidirectional data in real time according to claim 16, wherein the data detecting section comprises a liquid injecting section for injecting a liquid equal to the liquid for adjustment of zero point when the zero points of the first pressure sensor and the second pressure sensor are not equal to each other.

18. A defecation disorder diagnosing apparatus having a function of verifying bidirectional data in real time according to claim 15, further comprising an abdominal electromyogram electrode to be attached to a human body, as a biological signal measuring electrode for detecting influence which a force applied to an abdomen in defecation gives to an defecatio system,
wherein the control unit compares a pressure value corresponding to a voltage value measured using the abdominal electromyogram electrode with any one of the dynamic pressure value and the static pressure value measured using the rectum inserting catheter, to verify validity of the measured data.
